(19) United States
(12) Patent Application Publication
(10) Pub. No.: US 2009/0198519 A1
(43) Pub. Date: Aug. 6, 2009

(54) SYSTEM FOR GENE TESTING AND GENE RESEARCH WHILE ENSURING PRIVACY

(76) Inventor: Richard Timothy McNamar, Falls Church, VA (US)

Correspondence Address: FOLEY AND LARDNER LLP;SUITE 500, 3000 K STREET NW, WASHINGTON, DC, 20007, US

(21) Appl. No.: 12/363,499

(22) Filed: Jan. 30, 2009

Related U.S. Application Data
(60) Provisional application No. 61/006,785, filed on Jan. 31, 2008.

(51) Int. Cl. G06Q 50/00; G06F 17/30

(52) U.S. Cl. 705/3; 707/5; 707/E17.032; 707/E17.014

(57) ABSTRACT

A system, method and program product, the method comprising, in one embodiment, providing a secure testing service for patient's identification and payment data encrypted at the data level, non-identifiable method for a patient to have a genetic tests to identify variants or mutations of their genes or combinations of genes that predispose the patient to develop or have an identified disease, comprising: obtaining electronically genomic information for a patient comprising at least one of, (a) DNA information, (b) RNA information, (c) complementary DNA or RNA information, (d) transfer RNA (tRNA) information (e) messenger RNA (mRNA) information, and (f) Expressed Sequence Tags (EST) to identify an abnormal gene; searching by one or more computers electronic databases using the identified abnormal gene to obtain genetic sequencing and basic research, patient predispositions, and pharmacognetics that predict the response and reaction of patients with identified genetic abnormalities related to the identified abnormal gene and individual medications that may be prescribed relating to the identified abnormal gene or a relationship with said identified abnormal gene; performing an update search on at least a periodic basis to learn about subsequent genomic research developments and treatments for the identified abnormal gene, specific genes with variants or mutated genes identified in the genetic test; sending electronically via an Internet communication link data comprising or derived from the searching step and the update search to the patient or a third party; and with the sending step performed using a privacy component that prevents transmission to any third party unless predetermined permission clearance data is in the system.

### CROSS-REFERENCE TO RELATED PATENT APPLICATIONS

This application claims priority from Provisional Application U.S. Application 61/006,785, filed Jan. 31, 2008, incorporated herein by reference in its entirety. This application incorporates by reference U.S. Provisional Patent Application No. 60/841,529 filed Sep. 1, 2006, U.S. Provisional Patent Application 60/957,094 filed Aug. 21, 2007, U.S. Provisional Patent Application 60/987,603 filed Nov. 13, 2007 and U.S. patent application Ser. No. 11/740,122 filed Apr. 25, 2007. These applications are incorporated herein in their entireties.

### BACKGROUND

Medical testing and the use of test results have always raised patients' privacy issues concerning who can see the test results and the use or misuse of the test results. Historically, the results of a certain laboratory test raised issues of discrimination toward the test taker, e.g., a positive HIV test. With the introduction of genetic testing, the results of a test may result in discrimination against several generations of the test takers' family. This is compounded by the possibility of incomplete or inaccurate medical science in misinterpreting the test results. Genetic testing geometrically increases the risk of misinterpretation or misuse of one generation's test results to discriminate against the test takers' children and grandchildren for employment or insurance rating purposes.

However, the promise of genetic testing and genetically tailored prescriptions has extraordinary positive medical benefits. This field is growing very rapidly and there are already over 1,000 genetic tests available from over 600 non-research clinics and laboratories. A 2008 draft study of the HHS Advisory Committee on Genetics, Health and Society indicated that today genetic tests were useful to 2% of the population (including children and elderly). That number is projected to grow to 60% of the population when the tests already under development are available commercially in the coming months. Over the next decade, the proportion of the population that may benefit from genetic testing will continue to grow, and their costs will decrease. Further, additional multi-variable analysis will increase the diagnostic confidence of the analyses.

In the coming years, the medical profession will be educated about genetic tests, and the patients will become aware of them and ask their physician about them. The HHS Advisory Committee described the tests as “growing at an explosive rate” and said that the medical profession's education efforts, “ . . . cannot keep up with the pace of development of genetic tests.” The Advisory Committee recognized that genetic tests were now being offered not just through doctors, but also directly to consumers bypassing doctors. Direct testing raises both test interpretation issues and privacy issues, because of direct identification of the test requestor, credit card payment record, etc.

Recognizing the issues relating to accurate interpretation of genetic test results, there is unquestioned patient healthcare value to the proper use of genetic tests by trained physicians. Nevertheless, some patients are reluctant or refuse to take the tests because they do not want to know the results. A probably much larger number do not take the tests for fear that their genetic predispositions will become known to their current or prospective employer or life and health insurance companies through data mining or other means. A person's genetic predisposition can result in loss of employment or the inability to be hired. The life insurance industry's medical database can contain this data and be widely available. Patients also fear that they will have to produce these test results in court in an adverse legal proceeding and will be compelled to produce them in a lawsuit.

In 2007, the Center for Genetics and Public Policy conducted a survey of consumer attitudes toward the use of genetic test's data. Their principle conclusion was that:

“The majority of Americans enthusiastically support genetic testing for research and health care, but a large majority (92%) also expresses concern that results of a genetic test that tells a patient whether he or she is at increased risk for a disease like cancer could be used in ways that are harmful to the person.”

In the Survey, 86% of the participants would trust their physician with their genetic test results, but fewer than one out of five trusted their employer with the information fearing discrimination based on genetic testing. An identical 93% of the respondents felt that the results should not be used by an employer for future advancement or promotion and also that insurance companies should not be able to use the results to deny future coverage or charge higher rate insurance premiums. Over three out of four surveyed felt that there should be a law that prevents employers from using genetic test results about risk of future disease and also to deny or limit insurance or charge higher prices. (The Survey had a confidence level of plus or minus 2.7%.)

As a result of individuals legitimate privacy fears, many, perhaps most, individuals and their doctors do not take genetic tests, even those that may be most helpful in their own life style decision making, healthcare regime, or even prophylactic treatment. This fear of loss of privacy appears to be the prominent attitude in the patient population. Once educated on these privacy issues, people are still exceedingly reluctant to take genetic tests that may be extremely helpful to them medically.

Searching for Updated Information for Mutated Genes

In addition, there is no way for a patient who takes a genetic test to search about the genetic research that relates to the abnormal genes that they possess. To follow developments in the field of genetics or genetic medicines related to their particular abnormal genes an individual must at present they must search all of the professional medical journals, Google the genes of particular interest to them or rely on their doctors to provide them the information that they have found. Unfortunately, since Google rankings are based on the number of times that a story, subject, or hyper-text format page (HTML page) is referenced in the internet, the reference to a particular gene may not be prominently displayed or may rank so low that it is not effectively found by an individual using Google or the gene is not linked or related to other genes sufficiently often to be searchable by the patient or the patient's doctor.

This situation is well illustrated by considering two different sets of genes found in women. Assume that a woman has abnormal BRAC1 and BRAC2 genes. Variants in the BRAC1 and BRAC2 genes appear to increase the probability of women getting certain types of breast cancer from heredity. They are widely know, many if not most women know this information, and they are searched on Google many thousands or millions of times a day on a world wide basis. As a result, they are highly ranked in the Google search. Now consider a woman with the variants of the BLK and ITGAM genes that contribute to the autoimmune disease Lupus. In the United States, Lupus affects an estimated 1.5 million Americans; less than 0.5% of the population. More importantly, only a small proportion of women with Lupus would be searching for BLK and ITGAM and therefore the search results on Google and other search engines would not highly display these search results.

Consider the number of search results referenced on the upper right corner of a Google display and the number displayed in the first ten or twenty pages of Google to realize that the search results for the BLK and ITGAM related stories are effectively not found and displayed by any search engine for a patient with variant genes searching for new updates. While newspaper stories about a development will provide enough “hits” to give the story temporary prominence that is not targeted effective search, or a consistent enduring ranking on Google.

Even more difficult is the search for information when more than one variant gene set is involved in the apparent abnormality that increases the probability of a disease. Again, using Lupus as an example, consider that the BLK and ITGAM genes are part of an estimated 20-30 genes linked to the disease. In the Jan. 22, 2008 Wall Street Journal, Dr. Timothy W Behrens and his colleagues reported in the New England Journal of Medicine used what is considered a significant powerful genetic-testing technology that is providing insights into previously unrecognized genes linked to Lupus. The more genes involved the relatively fewer the hits on Google, therefore the lower the information's rankings and the more difficult for a patient to search, discover or links subsequent information relating their variant genes. Google can find, but not array and display this information effectively and the individual with the mutated genes are often not able to effectively obtain the targeted or effective search of new information relating to ITGAM. The following Google search results for BLK and ITGAM were used to illustrate this point.

For example, at 8:00 PM EST on Jan. 28, 2008, Google produced the following search results for “BLK”: it has 34,400,000 search results, which are displayed 10 results at a time. For the first 25 pages of results or 250 results, results for the gene BLK were displayed only six times. All of the results were for the gene coding itself and took over ten minutes to identify. None of these results were obviously useful to an individual patient who had mutations of the BLK gene. The search results were not prominent, easily displayed, or usable from the search of the first 250 results. None of the six results told what the variant of the BLK gene might mean to a patient who was told that they had the variant gene. None of the search results provided any information relating to Lupus. There was no effective search or medically useful information for a patient with a mutation of the BLK gene seeking to be informed of new developments on an ongoing periodic basis.

By contrast, at 8:34 PM EST on Jan. 28, 2008, Google produced the following search results for “ITGAM”: it has 47,700 search results and the first ten displayed were about the protein ITGAM in detail for someone interested the sequencing of the gene itself. In the first ten results there were references to obesity, but not Lupus. Again, there was no effective search or medically useful information for a patient with a mutation of the BLK gene in the display of results an interested person might read.

A subsequent Google search for “ITGAM+Lupus” provided 3,270 search results. In this much smaller search, all of the first ten displayed search results appeared to be on point and it appeared that many search results would be useful to a patient who made this request. However, note that to receive the search result, the patient-searcher had to know the disease specified before the search. Since the purpose is to identify the disease caused by a variant in a gene rather than requiring the searcher to know a priori the disease that causes the genetic variant, the result shows the need for a an invention that searches for the disease and new developments in treatment knowing only the genetic title, “ITGAM.”

Even more interesting is the search for the gene BDFN. Mutations of this gene have been preliminarily identified as a cause [or the cause] of depression, a disease that is estimated to affect 30-50 million Americans. The story, “When Fretting Is Your DNA: Overcoming the Worry Gene” was in the Wall Street Journal on Jan. 15, 2008; Page D1. http://online.wsj.com/article/SB120035992325490045.html. Online it was the most read and most e-mailed story for the Wall Street Journal on that date. Hence it could be expected to be highly ranked by Google. However, a Google search for DBFN at 9:35 AM EST on Jan. 29, 2008 produced the following; there were 9,470 results. Of the first 100 results only the 34^{th} ranked result produced useful genetic or medical information about DBFN and depression. In the top 100 two others related DBFN to bulimia and adult weight loss. During the top 100 search results, the Wall Street Journal Story of January 15 was not ranked at all. Thus it is reasonable to conclude that a person interested in DBFN gene developments won't easily find them over time. At 9:49 AM EST, a more focused Google search of “DBFN+Depression” produced only 45 results, and did not include the Wall Street Journal. On the last page of results, the following notice appeared;

“In order to show you the most relevant results, we have omitted some entries very similar to the 32 already displayed. If you like, you can repeat the search with the omitted results included.”

When the Google search was repeated with the omitted results included, the same 45 results were repeated. Again, the Wall Street Journal story of Jan. 15, 2008 “When Fretting Is In Your DNA: Overcoming the Worry Gene.” did not appear in the 45 search results. This search for DBFN illustrates that there may be tens of millions of people who can not find the relevant newly developed information on Google as the research on DBFN and depression is further discovered and published in the future. Neither the patients suffering from depression nor their doctors are not likely to have better search results using Google. Hence a patient or doctor knowing a patient that has mutations of the DBFN gene does not have an effective way to inform themselves of subsequent developments relating to DBFN, nor possible treatments that may develop subsequent to the genetic test. Following the research and clinical developments in the genomic field is difficult without help.

For example, the mutated KRAS (K-ras) gene is found in most pancreatic and colon cancers. Data varies from study to study, but between 40 percent and 60 percent of newly diagnosed colon cancer patients have the well known non-mutated gene. The colon cancer treatments are part of the ongoing attention given to the K-ras gene and information showing it is a good determinant of how well a patient will respond to the class of drugs called EGF receptor inhibitors. Data from ImClone's Erbitux, presented at the American Society of Clinical Oncology gastrointestinal cancer meeting over the Jan. 26-27, 2008 weekend, suggest a benefit in patients with the non-mutated K-ras gene. Amgen's Vectibix is already approved in Europe as treatment for that class of patient and OSI's Tarceva could have the same benefit. To find this new treatment possibility, a patient would have to search the company web sites, the ASCO website or specific drugs to learn this information, because a search for K-ras on Google produces 492,000 results, and it is not clear that the results even contains this new information. The search results for 492,000 results does not indicate the data is presented in a “findable” way. Yet all the patient or his doctor may know is the mutated or non-mutated state of the patient's KRAS and that the patient has colon cancer. Because this new information isn't yet widely searched on the internet it doesn't rank high in the Google search results for KRAS at this time. Yet these are precisely the type of new developments that are vitally important to a cancer patient and their doctor.

Prior Art: In response to this wide-spread patient reluctance to genetic testing where the patient and their results can be identified, some laboratories have begun to offer anonymous testing and even some third-parties may have started offering this type of trusted third-party service. These are generally related to the laboratory offering the test and not and independent service that will work with all laboratories. None offer web based updates of research or clinical information focused on the mutated or variant genes identified in the requesting individual (patient's) genetic test.

There is prior art involving a trusted third-party payer, particularly on the internet. The service PayPal is the best known of these services, but they are not related to personal healthcare records, genetic testing, and do not provide an ongoing service, but are one time transactional services.

A United States Patent and Trademark Office search of patents and published applications using “genetic testing and privacy” for All Fields produced 57 responses, but none were close to the Invention. U.S. Pat. No. 6,944,767 Method and Apparatus for Ensuring the Privacy and Security of Personal Medical Information addressed the privacy issues, but with an unrelated apparatus or device.

Outside the United States Patent and Trademark Office, it appears that on Apr. 27, 2005 NTT announced the existence of a new product SecureName, which is an XML system to provide privacy protection in medical records. On Apr. 27, 2007, Microsoft announced an LLP partnership with NTT to use their SecureName technology. It appears that it is a part of the Microsoft Health Vault product, which has been in the public domain for less than one year prior to this filing. The NTT SecureName technology is XML and may be partial prior art for a portion of this Invention.

There is no prior art that permits a person to designate a particular gene, gene set, or linked set of genes to use in establishing an ongoing or recurring search of pathology research relating to the improvement in knowledge about a gene, its relationship to other genes or their probability of influencing or determining a patient's probability of contracting a certain disease or medical condition. There is no ability to search and identify the variants in gene, gene sequence, or linked gene behavior that provides the patient with any probabilities of disease, suggestion of changes in lifestyle or prophylactic treatment to either lessen the severity of a disease, to arrest its development, or to cause remission or treatment to alleviate its symptoms.

The Company 23 and Me was publicly launched Nov. 19, 2007. It provides a web based testing service for people to have their own genome sequence examined for $999 by sending in a sample, personal information, account information, and alike. The Company's Privacy Policy indicates that it will not sell the individual's personal, account, or genomic data without the individual's consent. The requesting individual's identification information is known to the Company prior to their data being destroyed. The Company says that it will sell the genomic information de-identified from the personal information, but it is not clear what restrictions exist on this. It links to other websites, but does not provide a service to follow up and inform the test taker of the new research and clinical information about their mutated genes. It does not provide privacy and security for patients wishing to use any laboratory. Last, it has not been in the public domain for a year or more and therefore is not prior art. See www.23andMe.com

Quest Diagnostics is a testing company for Physicians that performs genetic testing and offers interpretation of the test results and the counseling for the test taker. It does not provide updates on the genetic mutations of the test taker, and the test taker's identify is known to the laboratory. They would be a laboratory that the test taker or used through a physician on a confidential basis. See www.questdiagnostics.com

deCODE Genetics is genetic testing service company based in Iceland. It was launched Nov. 16, 2007. It provides an online service for individuals to use PayPal to pay and will provide genetic profiles of the individual. It provides a great deal of counseling and contest to help the test taker understand the results of their genetic test, which is performed by a related laboratory. They will also inform a test taker of updates in the research about their genes. The Company's main thrust is to help people understand their genetic profile compared to other individuals and groups and not as a medical diagnostic tool. The individual who requests the test is known to deCODE Genetics. See www.decodeme.com.

A fourth company, Navigenics, specializes in personalized consumer health and wellness services, with the overall goal of improving health outcomes in individuals across the population. Navigenics educates and empowers customers with knowledge of their genetic predispositions, and then motivates them to act on the information to prevent the onset of disease, achieve earlier diagnosis, appropriately manage disease, or otherwise lessen its impact. It was publicly launched on Nov. 6, 2007. It provides genetic testing, but not on an anonymous basis, the requester is known to the Company, and there is no indication that the Company will not sell the requesting party's genetic information or use it for other commercial purposes. In its $2,500 testing price, it specifically will provide of an update of new genetic discoveries for a year, but does not provide a continuing service, nor any search or updating based on the tested individual's mutated genes. See www.navigenics.com.

In sum, there is some prior art in many facets of the invention, but not for the invention itself. Most of the companies above, Navigenics, 23 and Me, deCODE Genetics, and Quest Diagnostics are testing laboratories that someone using the invention could access anonymously and be provided updates from their public reports as well as studies from Science, Nature, the New England Journal of Medicine, other medical journals in the United States and internationally, which can use XBRL's translation features to be linked in English to the gene or combination of mutated genes that are being tracked for the tested individual. All of these companies are potential testing facilities for the patient's that would use an anonymous genetic testing service.

All of the testing facilities mentioned, Navigenics, 23 and Me, deCODE Genetics, and Quest Diagnostics have begin operation within one year prior to the filing of this patent application, and most have been in the public domain only since the 4^{th} quarter of 2007.

### BRIEF DESCRIPTION OF THE DRAWINGS

FIG. 1 is an overview of the secure genetic testing invention.

FIG. 2 illustrates the continuous updating of newly developed genomic research or medical related advances for prescribing pharmaceuticals or advances in gene therapy.

FIG. 3 is an overview of the Patients Privacy Trust

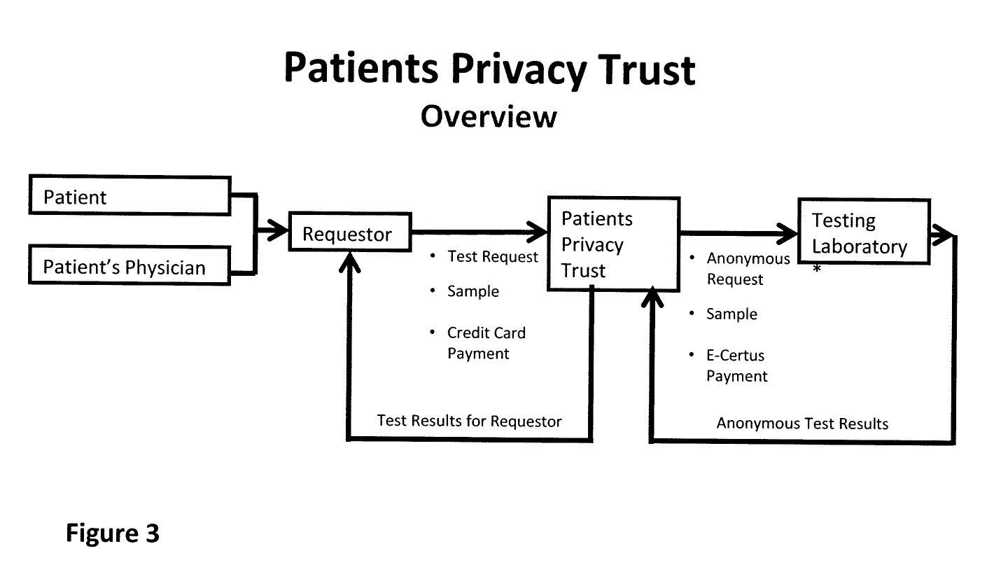

### DETAILED DESCRIPTION

The invention is a web based method and system using computer software employing the Extensible Business Reporting Language for enterprises (XBRL GL) and/or Extensible Healthcare Reporting Language (XHRL), to provide a secure testing service for patient's identification and payment data encrypted at the data level, non-identifiable method for a patient to have a genetic tests to identify variants or mutations of their genes or combinations of genes that predispose the patient to develop or have an identified disease. The genomic information comprises at least one of, (a) DNA information, (b) RNA information, (c) complementary DNA or RNA information, (d) transfer RNA (tRNA) information (e) messenger RNA (mRNA) information, and (f) Expressed Sequence Tags (EST). The computer software uses the identified abnormal genes to search for genetic sequencing and basic research relating to the identified abnormal genes or future combinations of genes not known at the time of the original test. This provides a service for the patient to learn about subsequent genomic research developments and treatments for the specific genes with variants or mutated genes identified in the genetic test. This includes searching for an identifying subsequently identified genetic sequences or relationships between genes and future pharmacognetics that predict the response and reaction of patients with identified genetic abnormalities to individual medications that may be prescribed, e.g. personalized or patient centric prescriptions based on their genetic composition. The software will also search for developments relating to predisposition to certain diseases and generational transmission of the predispositions.

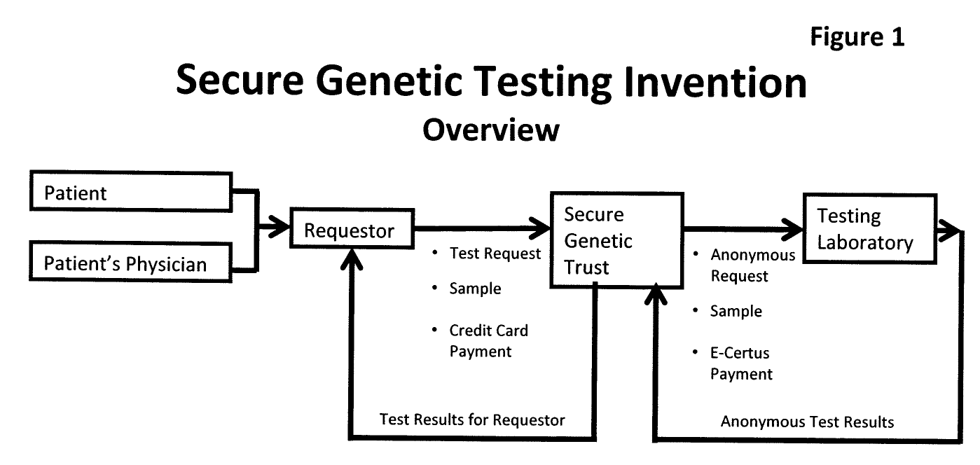

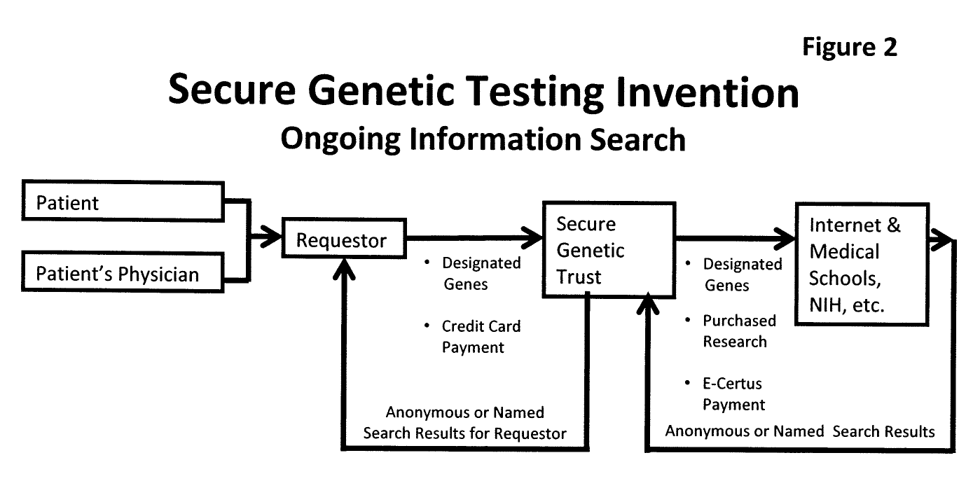

The software will provide an application programming interface to the genetic testing laboratories in the United States and internationally, such as Navigenics, 23 and Me, Quest Diagnostics, and deCODE Genetics, and others will be added. An XBRL GL or XHRL medical taxonomy will be electronically linked to all available research on the developments in genetics and therapeutic lifestyle changes or treatment of individuals with the variants in genetics identified in the secure or encrypted test results. It will search the internet for the relevant results relating to the specified genes and update the existing data base for the pre-specified gene. The software will then process, and transmit the focused search to the patient in a secure or non-secure manner to update the patient on medical developments that occur subsequent to the patient's first or initial genetic test. The software can also related diseases linked to certain mutated genes and identify future basic research and therapeutic of pharmacognetics developments for that disease relating to genes not found to be mutated in the original genetic test. This invention is illustrated in FIG. 1. The continuous updating of newly developed genomic research or medical related advances for prescribing pharmaceuticals or advances in gene therapy is illustrated in FIG. 2.

This invention incorporates by reference three previously filed patent applications. U.S. Patent Application No. 60/957,094 Methods, systems, and computer software using XBRL technology to electronically link independently developed topical sets of semantic medical vocabulary standards into a comprehensive XBRL taxonomy that enables a patient to have a single integrated electronic medical record with agreed upon definitions that can be interoperable on any computer using any software, which was filed Aug. 21, 2007. The second patent incorporated by reference is U.S. Patent Application No. 60/841,529 Methods systems and computer software utilizing XBRL to capture patient's health care data, including the patient's genotypic data or genotype to improve the matching of treatments drugs and devices to a patient's unique genetic make up, filed Sep. 1, 2006. The third patent incorporated by reference is U.S. Patent Application No. 60/987,603 Methods, systems, and computer software using individual and aggregate healthcare data, and morphing technology to morph an individual's digital photograph and life style data to project their probable appearance, aging, and health status over time given alternative life style choices, filed Nov. 13, 2007.

Embodiments: In one embodiment, the patient (or the patient's physician) indicates an interest in obtaining a genetic test of all or part of a patient's genetic make-up or sequencing. The anonymous Genetic Testing Service (the “GTS”) obtains and accepts the patient's DNA sample, instructions, and payment, and de-identifies the patient and all related material that could identify the patient. It does this by encrypting all individual data field in the patient's name, date of birth, address, and alike using a large encryption program, e.g., 258,000 factorial on each data item in the patient's name, address, date of birth and alike and storing the encrypted data off shore.

After de-identification, the GTS requests a genetic testing laboratory to conduct a specified genetic test on the patient's DNA de-identified sample. The GTS also pays the genetic testing laboratory from its bank account. After the genetic test is complete and the results are tabulated, the laboratory sends the genetic testing results to the GTS. The GTS then uses its internal encrypted key to identify the patient, and the GTS can then transmit the genetic test results to the patient or the patient and the patient's physician.

The GTS will establish application programming interfaces to the leading genetic testing facilities to request, process, and pay for the anonymous genetic testing and in turn to receive the genetic test results anonymously from the testing laboratory, e.g. 23 and Me or Navigenics, and deCODE Genetics, plus others on a global basis. Use of the GTS assures the patient or patient's physician that their identity can never be known by the testing laboratory, because they never received anything other than a GTS code.

After testing, the GTS computer software can identify the patient's genes that are mutated or the patient (or the patient's physician) can request the GTS to identify and report on all subsequent developments relating only to the genes identified as being variant in the genetic test or those specific genes designated by the patient or the patient's physician as being of interest to them. The GTS's computer software then does a periodic internet search of developments relating to the specified genes and uses a multi-factor search on the results, including frequency of mention, but also on closeness to the issue of healthcare implications for the patient. The search results are arrayed by degree of closeness to the patient's specified interest, frequency of mention in the rankings, and other factors to make the results as narrow or useful to the patient or the patient's physician for recommendations relating to changes in the patient's lifestyle or prescribed medicines for the patient given the original genetic variations, and the subsequent research knowledge about the gene, its links to other genes, combination of genes and internet search results relating to the changes in life style or medicines for the patient. These stratified or narrowed internet search results are arrayed, stored, and transmitted or made available to the patient in a secure manner so that the identify of the patient is not identifiable or even that the patient or patient's physician has requested or paid for the continued monitoring or is receiving the continued updates monitoring. In addition, all identification and payments records relating to the transaction (s) with the patient or the patient's physician are encrypted by individual data field and stored in a selected location or jurisdiction so that they may not be subpoenaed by a United States court or the court of the patient's home country.

In a second embodiment, The SGT will operate as follows. SGT would be a combination of physical processing and internet based services, all structured so that the information, physical sample, and test results are not owned by SGT, but only managed by them as a trustee of the patient owner. All of following actions are done by SGT acting as a trustee or agent for the patient owner of the data. The SGT would be a trust located in an appropriate jurisdiction and it would have a contract with a management company for management services to provide its member benefits.

To collect the samples the service would use FedEx or a similar service. The request for a test could come over the internet, by telephone, or by use of a pre-distributed set of sample collectors in doctor's offices or drug stores and FedEx prepaid addressed envelopes. If the request is over the internet, the requester can be sent the sample collection kit, a return pre-addressed FedEx envelop, and credit card authorization. These are all sent to a central processing facility, perhaps at the Memphis Airport to take advantage of the FedEx processing facility.

SGT would input and record the requesting party's data, encrypt it, and send it to an SGT server farm in a secure non-United States jurisdiction, currently assumed to be Singapore. The encryption would not only be of the requestor's name, but also all potentially identifying data such as address, credit card number, etc. These data would be encrypted using commercially available techniques, but on the meta-data on each letter in all of the potentially identifying data. Using available XBRL GL technology, each letter (data field) with a 258,000 factorial so that the combined factorials are so large they are beyond commercial code breaking feasibility.

The SGT would transmit the request for the test to the designated testing laboratory, forward the patient's sample, which has been de-identified, and pay the laboratory using SGT funds to cover the cost of the testing. After testing, the results would be transmitted to SGT, which would re-identify the requester of the test, and transmit the test results to the original requestor. This process is illustrated in the accompanying Exhibit I.

The SGT would retain no records of the requester, the requestor's payment method or the requestor's physician in the United States that could be subsequently subpoenaed in a lawsuit. Data on the requester, etc., outside the United States would only be retained for a limited time, and then it would be destroyed as a part of a regular data retention management program. Prior to destruction of the requestor's data, the SGT would maintain an electronic audit trail that indicates any request for, viewing, or modification of the requestor's demographic or payment information and subsequent test results information.

The SGT would provide secure and non-secure basis information about genetic research on specific genes and the interpretation of the meaning of mutations or abnormalities of genes or combination of linked genes. A non-test taker could subscribe on a non-secure or secure basis. A previous genetic test taker could subscribe on an anonymous basis that could not be related to their having taken a test and expressed an interest in following research and interpretation of findings concerning a particular gene or combination of genes.

This subscription service is expected to be popular because most people will only take their genetic test once or twice. To the extent that they identify one or a number of linked genes that contain a variant indicating a genetic predisposition, they can follow the medical research and best interpretative practices on that gene or combinations involving that gene without searching the Internet for all research. The SGT would search and rank the research, and provide it to the subscriber in a data feed RSS or e-mail or through a coded web site that only has information relating to the gene that the subscriber has designated to be of interest.

In a third embodiment, the GTS uses XML and its encryption capabilities to provide a less robust encryption of the patient data. Otherwise, the embodiments are identical with embodiment one and embodiment two described above in this application.

In a fourth embodiment, a patient has not been genetically tested, but wants to follow developments relating to genetic sequencing or medical research about a particular gene. No patient sample is collected or tested. However, the identification of the patient or patient's doctor requesting information of future developments on sequencing and possible lifestyle or therapeutic treatments is still de-identified and the information encrypted using XML or XBLR GL coding and formatting technology to protect the requesting party, their payment mechanism, etc. These records would also be established and stored in a jurisdiction where the party requesting the information could not be compelled to provide them by a court in the requesting party's home legal jurisdiction.

In a fifth embodiment, the patient or patient's physician does not do a genetic test for mutated genes, but rather specifies that they would like the literature on certain genes or combinations of genes tracked on an ongoing basis. This may be done as an anonominous request or done on an identified name basis. The software would accept this request, search, manage and transmit the future data on an ongoing basis. This is similar to the other embodiments above.

In a sixth embodiment, the computer software would use the set of identified mutated genes to search for future basic research and pharmacognetics related to them for the identified diseases the mutated genes predispose the patient to have. It would use that list of diseases to diseases to track developments relating to the patient's non-abnormal genes and subsequently relate them. In this embodiment, the computer software would provide a feedback loop of research and therapeutic information to the patient based on subsequent developments in the genetics or clinical treatments based on knowledge developed after the initial test. These data would be identified, sorted, stored, transmitted and displayed separately classified from the subsequently discovered information relating the patient's abnormal genes in the original test.

### Patients Privacy Trust Concept Paper

This paper develops the concept of the Patients Privacy Foundation (the “Foundation”) and e-certus (the “sponsors”) developing a service to provide assured anonymity to individuals taking sensitive laboratory tests, particularly genetic tests, and the ability to receive focused medical research literature concerning any genes they identify to monitor,. It outlines the privacy issues, and then discusses the desirability of establishing an anonymity service, and its operational features. It concludes with a discussion of the sponsors' objectives, outlines a financial arrangement, and lists next steps. This discussion draft is designed to stimulate additional ideas and proposals for final concept paper.

Privacy Issues

Medical testing and the use of test results have always raised patients' privacy issues concerning who can see the test results and the use or misuse of the test results. Historically, the results of a certain laboratory test raised issues of discrimination toward the test taker, e.g., a positive HIV test. With the introduction of genetic testing, the results of a test may result in discrimination against several generations of the test takers' family. This is compounded by the possibility of incomplete or inaccurate medical science in misinterpreting the test results. Genetic testing geometrically increases the risk of misinterpretation or misuse of one generation's test results to discriminate against the test takers' children and grandchildren for employment or insurance rating purposes.

However, the promise of genetic testing and genetically tailored prescriptions has extraordinary positive medical benefits. This field is growing very rapidly and there are already over 1,000 genetic tests available from over 600 non-research clinics and laboratories. A 2008 draft study of the HHS Advisory Committee on Genetics, Health and Society indicated that today genetic tests were useful to 2% of the population (including children and elderly). That number is projected to grow to 60% of the population when the tests already under development are available commercially in the coming months. Over the next decade, the proportion of the population that may benefit from genetic testing will continue to grow, and their costs will decrease. Further, additional multi-variable analysis will increase the diagnostic confidence of the analyses will

In the coming years, the medical profession will be educated about genetic tests, and the patients will become aware of them and ask their physician about them. The HHS Advisory Committee described the tests as “growing at an explosive rate” and said that the medical profession's education efforts, “ . . . cannot keep up with the pace of development of genetic tests.” The Advisory Committee recognized that genetic tests were now being offered not just through doctors, but also directly to consumers bypassing doctors. Direct testing raises both test interpretation issues and privacy issues, because of direct identification of the test requestor, credit card payment record, etc.

Recognizing the issues relating to accurate interpretation of genetic test results, there is unquestioned patient healthcare value to the proper use of genetic tests by trained physicians. Nevertheless, some patients are reluctant or refuse to take the tests because they do not want to know the results. A probably much larger number do not take the tests for fear that their genetic predispositions will become known to their current or prospective employer or life and health insurance companies through data mining or other means. A person's genetic predisposition can result in loss of employment or the inability to be hired. The life insurance industry's medical database can contain this data and be widely available. Patients also fear that they will have to produce these test results in court in an adverse legal proceeding and will be compelled to produce them in a lawsuit.

In 2007, the Center for Genetics and Public Policy conducted a survey of consumer attitudes toward the use of genetic test's data. Their principle conclusion was that:

“The majority of Americans enthusiastically support genetic testing for research and health care, but a large majority (92%) also express concern that results of a genetic test that tells a patient whether he or she is at increased risk for a disease like cancer could be used in ways that are harmful to the person.”

In the Survey, 86% of the participants would trust their physician with their genetic test results, but fewer than one out of five trusted their employer with the information fearing discrimination based on genetic testing. An identical 93% of the respondents felt that the results should not be used by an employer for future advancement or promotion and also that insurance companies should not be able to use the results to deny future coverage or charge higher rate insurance premiums. Over three out of four surveyed felt that there should be a law that prevents employers from using genetic test results about risk of future disease and also to deny or limit insurance or charge higher prices. (The Survey had a confidence level of 2.7% plus or minus.)

As a result of individuals legitimate privacy fears, many, perhaps most, individuals and their doctors do not take genetic tests, even those that may be most helpful in their own life style decision making, healthcare regime, or even prophylactic treatment. This fear of loss of privacy appears to be the prominent attitude in the patient population. Once educated on these privacy issues, people are still exceedingly reluctant to take genetic tests that may be extremely helpful to them medically.

In response to this wide-spread patient reluctance to genetic testing where the patient and their results can be identified, some laboratories have begun to offer anonymous testing and even some third-parties may have started offering this type of trusted third-party service. (The extent of anonymous testing today will be researched in the coming weeks.)

Establishing a Patients Privacy Trust

Given the magnitude of the problem and the projected growth of genetic tests, laboratories, and the education of the healthcare professionals on their value, there appears to be an opportunity to establish an anonymity service to meet the privacy needs of the patients and physicians. This service will provide assurance to them that their test results will be owned by them and only known to them. If they choose to involve their physician, the physician and patient can be assured that the doctor-patient confidentiality will be maintained.

The anonymity service, with the initial working title, Patients Privacy Trust (“PPT”) will be a trusted-third party that could provide assurance of anonymity through computer encryption of patient identities and the locating of the services records in a jurisdiction where they could not be subpoenaed in a United States civil lawsuit, e.g., Singapore. This is important to prevent the disclosure of not only the patient's test results, but also the fact that the patient even used the anonymity service. The anonymity service would legally only be the trustee for the patient's information, laboratory sample, and test results.

The anonymity service would utilize the Extensible Business Reporting Language (XBRL) with meta-data on all data fields to encrypt a patient's identifiers, payment method, code for sample, and alike. This will permit the commercial use of a 258,000 factorial on each letter or number (data field) in the patient's identifying data. It will also provide the capability for an electronic audit of any viewing of the data for security purposes. At present, e-certus has a patent pending on the electronic audit trail in healthcare. In late January, it will file a new patent on some additional features that will be disclosed to all individuals or organizations signing its NDA. After filing, these features in the business method patent will be public.

Given its planned policies, the PPT should be able to obtain an errors and omissions insurance policy that could provide very high limits, which could assure potential patients of the seriousness with which their anonymity would be protected, e.g., “$10 million per occurrence, and $100 million coverage.” The anonymity service's business model should enable it to obtain substantial coverage limits for reasonable premiums. The insurance could cover the fact that the service will neither data mine or sell the patient's data in anyway, and that violation of that policy can result in patient claims and payouts under the insurance policy.

These features combined with the endorsement or certification of the Patient Privacy Foundation should enable an anonymity service to dominate the secure genetic testing market In fact, the PPT can also offer a service to its test takers what will provide them with all of the new medical research on their specific genes that test with an abnormality.

This will ensure that they can securely receive all of the information focused only on the genes that they are concerned.

The PPT would not perform any testing or interpretation of genetic testing, nor make any recommendations concerning testing laboratories or physicians or services for the interpretation of the test results. It would simply be the trustee of the test requestor's data, and provide a subscription service of medical research findings relating to the genes the requester selected to be informed about in the future, e.g., BRAC 1 and BRAC2. In this role, it is an information service, and does not provide any analysis or interpretation of the data.

Products and Services

The PPT will do two things. First, it would provide guaranteed anonymity to genetic test takers and their physicians. Second, it would search and provide a subscription data service to the genetic test takers or their physicians concerning all future developments in medical research or interpretation of findings relating to the specific genes the test takers or their physicians specify.

Operational Features

The anonymity service, with the working title, Secure Genetic Testing (“PPT”) will operate as follows. PPT would be a combination of physical processing and internet based services, all structured so that the information, physical sample, and test results are not owned by PPT, but only managed by them as a trustee of the patient owner. All of following actions are done by PPT acting as a trustee or agent for the patient owner of the data. The PPT would be a trust located in an appropriate jurisdiction and it would have a contract with e-certus for management services to provide its member benefits.

To collect the samples the service would use FedEx or a similar service. The request for a test could come over the internet, by telephone, or by use of a pre-distributed set of sample collectors in doctor's offices or drug stores and FedEx prepaid addressed envelopes. If the request is over the internet, the requestor can be sent the sample collection kit, a return pre-addressed FedEx envelop, and credit card authorization. These are all sent to a central processing facility, perhaps at the Memphis Airport to take advantage of the FedEx processing facility.

PPT would input and record the requesting party's data, encrypt it, and send it to an PPT server farm in a secure non-United States jurisdiction, currently assumed to be Singapore. The encryption would not only be of the requestor's name, but also all potentially identifying data such as address, credit card number, etc. These data would be encrypted using commercially available techniques, but on the meta-data on each letter in all of the potentially identifying data. Present plans are to encrypt each letter (data field) with a 258,000 factorial so that the combined factorials are so large they are beyond commercial code breaking feasibility. This level of encryption and the accompanying procedures should ensure that PPT purchase substantial amounts of insurance to advertise to potential users.

The PPT would transmit the request for the test to the designated testing laboratory, forward the patient's sample, which has been de-identified, and pay the laboratory using PPT funds to cover the cost of the testing. After testing, the results would be transmitted to PPT, which would re-identify the requestor of the test, and transmit the test results to the original requester. This process is illustrated in the accompanying Exhibit I.

The PPT would retain no records of the requester, the requestor's payment method or the requestor's physician in the United States that could be subsequently subpoenaed in a lawsuit. Data on the requester, etc., outside the United States would only be retained for a limited time, and then it would be destroyed as a part of a regular data retention management program. Prior to destruction of the requestor's data, the PPT would maintain an electronic audit trail that indicates any request for, viewing, or modification of the requestor's demographic or payment information and subsequent test results information.

Subscription Genetic Data Service

The PPT would provide secure and non-secure basis information about genetic research on specific genes and the interpretation of the meaning of mutations or abnormalities of genes or combination of linked genes. A non-test taker could subscribe on a non-secure or secure basis. A previous genetic test taker could subscribe on an anonymous basis that could not be related to their having taken a test and expressed an interest in following research and interpretation of findings concerning a particular gene or combination of genes.

This subscription service is expected to be popular because most people will only take their genetic test once or two times at the most. To the extent that they identify one or a number of linked genes that contain a variant indicating a genetic predisposition, they can follow the medical research and best interpretative practices on that gene or combinations involving that gene without searching the Internet for all research. The PPT would search and rank the research, and provide it to the subscriber in a data feed RSS or e-mail or through a coded web site that only has information relating to the gene that the subscriber has designated to be of interest.

The value of a subscription service to track genomic research and empirical medical treatments relating to the gene is confirmed by two articles in the Jan. 22, 2008 Wall Street Journal. They demonstrate both the pace of development in genetic testing and need for a carrier of a mutated gene to know the developments in medicine relating to that specific gene.

First, the Wall Street Journal reported discovery of two new genes, BLK and ITGAM that contribute to the autoimmune disease Lupus. Lupus affects an estimated 1.5 million Americans and is widely considered to be under diagnosed and reported. The two genes are part of an estimated 20-30 genes linked to the disease. Dr. Timothy W Behrens and his colleagues reporting in the New England Journal of Medicine used what is considered a significant powerful genetic-testing technology that is providing insights into previously unrecognized genes linked to Lupus. A subscriber to the service would receive all of the future research related to the research on the BLK and ITGAM genes and their links.

Second, the same Wall Street Journal reported three studies about the identification of the gene mutation in KIF6, estimated to be present in 60% of the population and that causes a 55% increase in the risk of stroke or heart attack. “The impact of the variant was independent of such conventional cardiovascular risk factors as smoking status, cholesterol levels and diabetes.” Importantly, the studies confirmed that carriers of the variant taking a statin to lower cholesterol had improvements in their risk of heart attacks and strokes. For example, individuals with the KIF6 variant had a 37% reduction in their risk of heart attack by taking the statin Pravachol independent of other variables, e.g. smoking or non-smoking. These results are reported in four large studies involving over 30,000 patients, and the results are available at http://content.online-jacc.org/in_press.dtl, which is the online edition of the American Journal of Cardiology. Several laboratories are beginning to market a $200 genetic test for KIF6.

No only will carriers of mutated genes wish to follow the development of genetic research about them, but their physicians will have a keen interest in following the developments. The Wall Street Journal reported that one cardiologist involved in the KIF6 study said, “the results ‘take us one step closer to personalized medicine’ in which doctors use genetic data to tailor therapy for patients.” It is reasonable to assume that a patient's physician will have an interest in following a tested patient with variants not only to improve treatment, but to minimize their risk of future malpractice suits for failure to use the latest available treatment in personalized medicine.

In sum, the proliferation of ever less expensive genetic tests marketed to physicians and directly to the public plus the continuing developments of genetic research suggests that the demand of the subscription service is growing. Again, it can be offered on a secure basis to previous genetic test takers or to others interested in following a research about a particular gene. The subscription service can become a useful tracker of developments for personalized genetic medicine on a gene by gene basis.

Privacy Foundation Leadership

At this time, most of the operational details remain to be developed, assuming there is agreement on the concept, approach, and market opportunity. The Foundation would be the public face of the PPT and handle all public relations and press concerning its operation, supported by e-certus as necessary. In effect, the PPT would be the Foundation's private label testing service to provide anonymity services to patients.

The Foundation will take the lead in the education of the public to teach them that there are both benefits from genetic testing and privacy issues relating to genetic testing, that PPT is available, and how it can protect their medical privacy. PPT can help the Privacy Foundation prepare material; arrange press and television appearances, etc. However, the Foundation will have full editorial control over the material except for technical operating matters, which will be joint control.

Sponsors Objectives

The Foundation wishes to inter into an exclusive relationship with e-certus to launch and build the PPT. Similarly, e-certus wishes to enter into an exclusive relationship with the Foundation to launch and build the PPT. Each believes that the other sponsor can help them increase patient privacy, particularly around the question of genetic testing, and helping patients find out targeted information about medical developments relating the genetic markers that the patient designates. The Foundation will not work on a similar product or service with another Company. And, e-certus will not work with nor license any of its intellectual property with another Company or organization on a similar product or service.

The Foundation needs to promote awareness and education about medical health records privacy. Educating the public is a major challenge. In addition, if the Foundation can sponsor a service that meets its policy objectives and standards it will increase awareness in the general community. If it can ensure that a patient's genetic testing data is not misused, it may promote the responsible use of genetic testing and limit the potential for patient's private test data to be misused. If it can help patients by narrowing their search for information to only the future research and best practices healthcare interpretation of new information about a gene or combination of genes, it can minimize the probability that this will lead to employment or insurance misuse of genetic testing results. These objectives may be achieved by the Foundation receiving cash flow from the PPT operations that can support the Foundation in a number of its related patient privacy activities, e.g., legislative changes.

e-certus' objectives are to demonstrate in healthcare several of the features of its XBRL coding, formatting, and linking technology, which directly support the Foundation's patient privacy objectives. This very high profile effort with the Foundation is congruent with e-certus' short-term revenue and profit objectives, but also increases the visibility and acceptance of its XBRL based technology in healthcare, and particularly the Health Care Information Technology Standards Panel (“HITSP”) effort, where it seeks to be designated the national data standard for healthcare under Executive Order 13410. The Company believes that only its technology will achieve all of the Foundation's privacy objectives, which it supports.

Both sponsors agree that the Foundation will be the public face or identity of the PPT and that e-certus will provide the legal, technical, managerial services to PPT. The PPT will reimburse the Foundation for normal and customary expenses incurred on behalf of the PPT. Each of the sponsors will enter into an agreement licensing their respective names, intellectual properties (patents and copyrights), business methods, etc. to the PPT, which at present is assumed to be an LLC, probably domiciled outside the United States. The intent is that this will be a long-term and hopefully permanent business relationship. The location of the testing service and the ongoing subscription data feed are being evaluated at this time.

e-certus will assume the responsibility for capitalizing the PPT, preparing a business plan that includes examination of legal issues and technical operation. Foundation will be involved in this process and their involvement sought. In addition, PPT and e-certus will have separate accounting system for all related expenditures and Foundation will have complete access to this information subject to the normal and customary business practices.

Further, Foundation will select a nationally recognized certified public accounting firm for PPT and to audit the e-certus expenditures relating to PPT. The expense of the certified public accounting firm will be paid by PPT. The public accounting firm will be specifically charged with ensuring that e-certus does not overcharge the PPT with inappropriate expenses.

I claim as follows:

1. An Internet-based method using computer software employing the Extensible Business Reporting Language for enterprises (XBRL GL) and/or Extensible Healthcare Reporting Language (XHRL), to provide a secure testing service for patient's identification encrypted at the data level, non-identifiable method for a patient to have a genetic tests to identify variants or mutations of their genes or combinations of genes that predispose the patient to develop or have an identified disease, comprising:
obtaining electronically genomic information for a patient comprising at least one of, (a) DNA information, (b) RNA information, (c) complementary DNA or RNA information, (d) transfer RNA (tRNA) information (e) messenger RNA (mRNA) information, and (f) Expressed Sequence Tags (EST) to identify an abnormal gene;
searching by one or more computers electronic databases using the identified abnormal gene to obtain genetic sequencing and basic research, patient predispositions, and pharmacognetics that predict the response and reaction of patients with identified genetic abnormalities related to the identified abnormal gene and individual medications that may be prescribed relating to the identified abnormal gene or a relationship with said identified abnormal gene;
performing an update search on at least a periodic basis to learn about subsequent genomic research developments and treatments for the identified abnormal gene, specific genes with variants or mutated genes identified in the genetic test;
sending electronically via an Internet communication link data comprising or derived from the searching step and the update search to the patient or a third party; and
with the sending step performed using a privacy component that prevents transmission to any third party unless predetermined permission clearance data is in the system.

2. The method as defined in claim 1, further comprising providing an application programming interface for accessing genetic testing laboratories in the United States and internationally, using an XBRL GL or XHRL medical taxonomy electronically linked to available research on the developments in genetics and therapeutic lifestyle changes or treatment of individuals with the variants in genetics identified in the secure or encrypted test results, as it pertains to the identified abnormal gene and update the existing data base for the pre-specified gene.

3. The method as defined in claim 1, wherein the predetermined permission data comprises identified third parties that may receive the transmission based on a patient certification.

4. The method as defined in claim 1, further comprising transmitting electronically an electronic update for a patient medical record maintained in a central database developments.
